(19) United States
(12) Patent Application Publication
(10) Pub. No.: US 2025/0369408 A1
(43) Pub. Date: Dec. 4, 2025

(54) ENGINE

(71) Applicants: Hiroshi OYAGI, Kyoto-shi (JP); Hirokazu ITO, Nagaizumi-cho (JP); Kazuhiko SEGUCHI, Nagaizumi-cho (JP); Kiyotaka TANAKA, Aki-gun (JP); Akihiro OGAWA, Aki-gun (JP)

(72) Inventors: Hiroshi OYAGI, Kyoto-shi (JP); Hirokazu ITO, Nagaizumi-cho (JP); Kazuhiko SEGUCHI, Nagaizumi-cho (JP); Kiyotaka TANAKA, Aki-gun (JP); Akihiro OGAWA, Aki-gun (JP)

(21) Appl. No.: 19/218,972

(22) Filed: May 27, 2025

(30) Foreign Application Priority Data
May 30, 2024 (JP) 2024-088125

(51) Int. Cl. F02M 26/45; F02M 26/00

(52) U.S. Cl. CPC F02M 26/45; F02M 2026/001

(57) ABSTRACT

An engine configured to prevent a variation in constituents of exhaust gas flowing into an EGR passage. The engine comprises: a header pipe joined to a cylinder; an EGR passage through which exhaust gas emitted from the cylinder is recirculated to an intake pipe; a vortex chamber to which the header pipe is connected; a receiving surface with which the exhaust gas flowing into the vortex chamber collides; an exhaust gas purification device; and a connector pipe connecting the vortex chamber to the exhaust gas purification device. One end of the exhaust gas recirculation passage is joined to the connector pipe.

### CROSS-REFERENCE TO RELATED APPLICATIONS

The present disclosure claims the benefit of Japanese Patent Application No. 2024-088125 filed on May 30, 2024 with the Japanese Patent Office, the disclosure of which is incorporated herein by reference in its entirety.

### BACKGROUND

### Field of the Invention

Embodiments of the present disclosure relate to the art of an engine having an EGR passage for recirculating exhaust gas resulting from combustion of an air-fuel mixture back to cylinders where combustion of the air-fuel mixture takes place, and an exhaust gas purification device for purifying the exhaust gas.

### Discussion of the Related Art

JPH09-236053 describes an engine having an exhaust manifold that collects exhaust gas flowing out of cylinders, and an exhaust gas purification device (i.e., a catalytic converter) disposed downstream of the exhaust manifold. In order to reduce a required heat resistance of an O₂ sensor for detecting an oxygen concentration in the exhaust gas flowing through the exhaust manifold, according to the teachings of JPH09-236053, a recessed space is formed on an exhaust passage, and the O₂ sensor is arranged in the recessed space while being oriented to a collector section. In the engine taught by JPH09-236053, an EGR passage is connected to the recessed space to recirculate the exhaust gas from the exhaust manifold to the cylinders.

Thus, in the engine described in JPH09-236053, the O₂ sensor is arranged in the recessed space, and the EGR passage is connected to the recessed space. Therefore, an oxygen concentration in the exhaust gas flowing through the EGR passage may be detected accurately. However, during operation of the engine, cylinders discharging the exhaust gas are switched in order and hence an oxygen concentration in the exhaust gas may vary in each cycle. Therefore, in the EGR passage, the oxygen concentration in the exhaust gas flowing ahead thereof and the oxygen concentration in the following exhaust gas may be different from each other. For this reason, an EGR valve has to be controlled in a complex manner so as to properly control a flow rate of the exhaust gas flowing through the EGR passage. For example, if too much exhaust gas is recirculated to the cylinders, an engine misfire may occur. By contrast, if the exhaust gas recirculated to the cylinders is insufficient, nitrogen oxide (Nox) may be generated undesirably.

### SUMMARY

Aspects of embodiments of the present disclosure have been conceived noting the foregoing technical problems, and it is therefore an object of the present disclosure to provide an engine configured to prevent a variation in constituents of exhaust gas flowing into an EGR passage.

In order to achieve the above-explained objective, according to the exemplary embodiment of the present disclosure, there is provided an engine, comprising: a plurality of cylinders; a header pipe that is joined to the cylinder so that exhaust gas emitted from the cylinder flows therethrough; an exhaust gas recirculation passage through which the exhaust gas emitted from the cylinder is recirculated to an intake pipe extending upstream of the cylinder; a vortex chamber to which the header pipe is connected; a receiving surface that is formed in the vortex chamber such that the exhaust gas flowing into the vortex chamber from the header pipe collides with the receiving surface to be diffused in the vortex chamber; an exhaust gas purification device that purifies the exhaust gas; and a connector pipe connecting the vortex chamber to the exhaust gas purification device. In the engine, one end of the exhaust gas recirculation passage is joined to the connector pipe.

In a non-limiting embodiment, the engine may further comprise: an exhaust gas recirculation valve that alters an opening degree of the exhaust gas recirculation passage; a sensor that transmits a detection signal representing an amount of oxygen contained in the exhaust gas; and a controller that controls the exhaust gas recirculation valve based on the detection signal transmitted from the sensor. In the engine, the sensor is arranged in the connector pipe.

In a non-limiting embodiment, the receiving surface may extend in a direction perpendicular to a streamline of the exhaust gas emitted from the header pipe.

In a non-limiting embodiment, one end of the header pipe may protrude into the vortex chamber.

Thus, the engine according to the exemplary embodiment of the present disclosure is provided with the vortex chamber in which the exhaust gas emitted thereto from the header pipe collides with the receiving surface. According to the exemplary embodiment of the present disclosure, therefore, the exhaust gas flowing into the vortex chamber from the cylinders may be diffused in the vortex chamber. In the engine, constituents of the exhaust gas emitted from each of the cylinders may differ from one another, and constituents of the exhaust gas emitted from the header pipes may vary in each cycle. However, the exhaust gas flowing into the vortex camber from the header pipes is diffused in the vortex chamber so that the constituents of the exhaust gas in the vortex chamber are averaged. In the engine according to the exemplary embodiment of the present disclosure, the exhaust gas whose constituents are averaged is emitted from the vortex chamber into the connector pipe, and recirculated to the cylinders through the exhaust gas recirculation passage. For this reason, variations in concentrations of oxygen and carbon dioxide in the air-fuel mixture in the cylinders may be reduced so that the constituents of the air-fuel mixture in the cylinders may be controlled properly. Accordingly, an oxygen concentration in the air-fuel mixture will not be reduced excessively, in other words, a carbon dioxide concentration in the air-fuel mixture will not be increased excessively. Therefore, an occurrence of engine misfire may be prevented. Likewise, the oxygen concentration in the air-fuel mixture will not be increased excessively, in other words, the carbon dioxide concentration in the air-fuel mixture will not be reduced excessively. Therefore, nitrogen oxide (Nox) will not be generated undesirably.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a front view schematically showing a structure of the engine according to the exemplary embodiment of the present disclosure;

FIG. 2A is a plan view showing one example of a structure of a vortex chamber, and FIG. 2B is a front view of the vortex chamber shown in FIG. 2A;

FIG. 3A is a plan view showing another example of a structure of the vortex chamber in which a collector pipe protrudes into the vortex chamber, and FIG. 3B is a front view of the vortex chamber shown in FIG. 3A; and

FIG. 4 is a plan view showing still another example of a structure of the vortex chamber in which a plurality of header pipes are connected to the vortex chamber.

### DETAILED DESCRIPTION OF THE PREFERRED EMBODIMENT(S)

Embodiments of the present disclosure will now be explained with reference to the accompanying drawings. Note that the embodiments shown below are merely examples of the present disclosure, and do not limit the present disclosure.

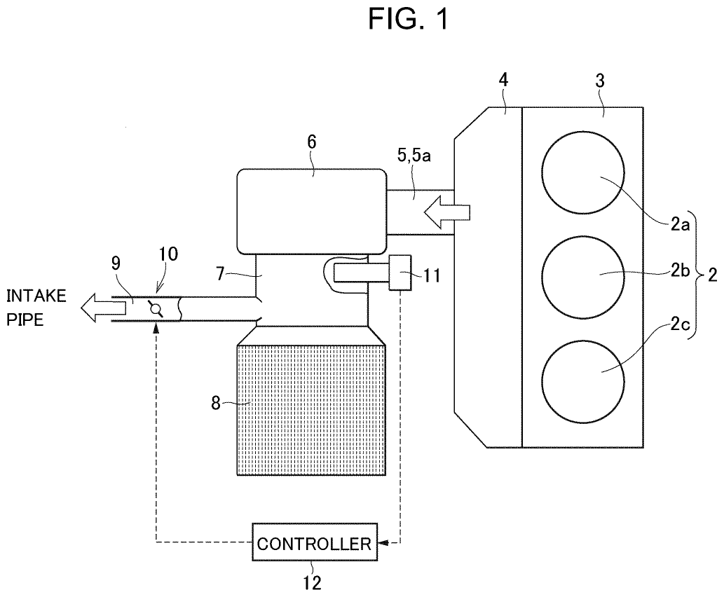

Turning now to FIG. 1, there is shown one example of an engine 1 according to the exemplary embodiment of the present disclosure. For example, a gasoline engine and a diesel engine may be adopted as the engine 1. As illustrated in FIG. 1, the engine 1 comprises: a cylinder block 3 in which a plurality of cylinders 2 are formed; a cylinder head mounted on an upper surface of the cylinder block 3; and a crank case (not shown) joined to a lower surface of the cylinder block 3. Specifically, the engine 1 shown in FIG. 1 is a three-cylinder engine in which a first cylinder 2a, a second cylinder 2b, and a third cylinder 2c are formed in the cylinder block 3.

In the embodiment to be explained hereinafter, a four-stroke engine is adopted as the engine 1. In the four-stroke engine 1, each piston (not shown) completes four separate strokes while turning a crankshaft (not shown) of the engine 1. Specifically, each of the pistons experiences two strokes per revolution of the crank shaft in the following order: an intake stroke in which air is pulled into the cylinder 2; a compression stroke in which an air-fuel mixture is compressed by the piston; a combustion stroke in which the compressed air-fuel mixture is ignited; and an exhaust stroke in which a resultant exhaust gas is expelled from the cylinder 2.

Each of the pistons is individually held in the cylinder 2 while being allowed to reciprocate in the axial direction of the cylinder 2, and individually connected to the crankshaft through a connecting rod.

Upper openings of the cylinder 2 are closed by the cylinder head 4. For example, intake ports for introducing air to the cylinders 2, exhaust ports for discharging the exhaust gas generated in the cylinders 2, and ignition plugs for igniting the air-fuel mixture in the cylinders 2 (neither of which are shown) are arranged in the cylinder head 4.

In the cylinder head 4, an intake manifold (not shown) is connected to an upstream side of the cylinders 2, and an exhaust manifold 5 is connected to a downstream side of the cylinders 2. Specifically, the intake manifold comprises: a main intake pipe for introducing external air through an air cleaner and a throttle valve; and a plurality of branch pipes branched from a downstream section of the main intake pipe each of which is individually connected to an intake port. On the other hand, the exhaust manifold 5 comprises: a plurality of header pipes individually joined to exhaust ports (neither of which are shown); and a collector pipe 5a extending from the header pipes. In FIG. 1, only the collector pipe 5a of the exhaust manifold 5 are shown for the sake of illustration.

In the engine 1 having a plurality of the cylinders 2, the exhaust gas is discharged from the first cylinder 2a, the second cylinder 2b, and the third cylinder 2c at different timings.

In addition, constituents of the exhaust gas may vary depending on a timing to ignite the air-fuel mixture and an oxygen concentration in the air-fuel mixture. Therefore, the constituents of the exhaust gas emitted from each of the cylinders may differ from one another. Consequently, the constituents of the exhaust gas emitted from the exhaust manifold 5 may be changed from those of the exhaust gas emitted previously from the exhaust manifold 5.

Specifically, the timings to ignite the air-fuel mixture and the oxygen concentration in the air-fuel mixture are controlled in each cycle. Consequently, the oxygen concentration in the exhaust gas emitted from the exhaust manifold 5 is changed from the oxygen concentration in the exhaust gas emitted previously from the exhaust manifold 5.

For example, an oxygen concentration of the air-fuel mixture is controlled by recirculating the exhaust gas to the intake pipe thereby mixing the exhaust gas with the air. However, the constituents of the exhaust gas emitted from the exhaust manifold 5 vary as explained above. Therefore, the constituents of the air-fuel mixture may not be controlled properly. In addition, in order to properly control the constituents of the air-fuel mixture, it is difficult to control a flow rate of the exhaust gas recirculated to the intake pipe.

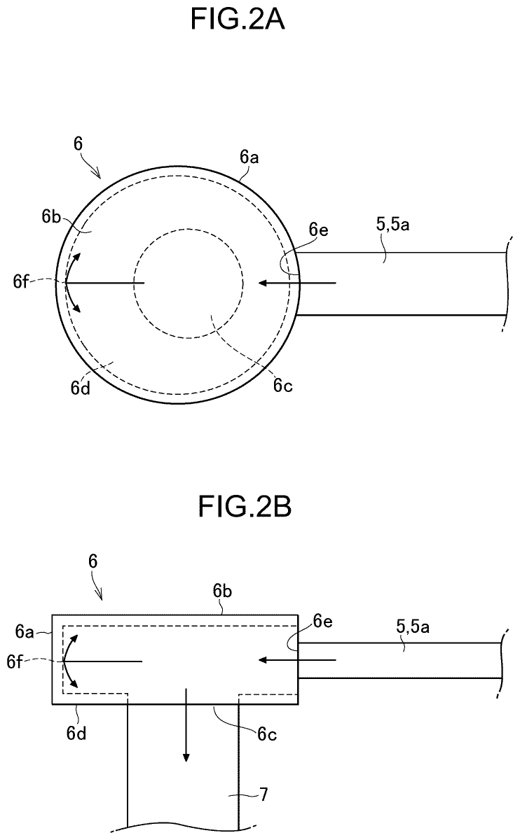

In order to avoid the above-explained disadvantages, in the engine 1 shown in FIG. 1, a vortex chamber 6 is joined to a downstream end of the exhaust manifold 5 so that the exhaust gas emitted from the exhaust manifold 5 is diffused in the vortex chamber 6. One example of a structure of the vortex chamber 6 is shown in FIGS. 2A and 2B in more detail.

As illustrated in FIGS. 2A and 2B, the exhaust gas emitted from the exhaust manifold 5 collides with an inner wall surface of the vortex chamber 6. Consequently, the exhaust gas is diffused three-dimensionally, and the diffused exhaust gas remains temporarily in the vortex chamber 6. Therefore, the exhaust gas flowed into the vortex chamber 6 in advance and diffused therein is mixed with the exhaust gas flowing into the vortex chamber 6 subsequently. Specifically, the vortex chamber 6 shown in FIGS. 2A and 2B comprises: a cylindrical wall 6a; an upper wall 6b closing an upper end of the cylindrical wall 6a liquid-tightly; and a lower wall 6d in which an outlet hole 6c is formed. An inlet hole 6e is formed on the cylindrical wall 6a, and the exhaust manifold 5 is joined to the inlet hole 6e so that the exhaust gas emitted from the exhaust manifold 5 flows into the vortex chamber 6.

In the vortex chamber 6, a portion of an inner surface of the cylindrical wall 6a opposed to the inlet hole 6e serves as a receiving surface 6f. The exhaust gas flowing into the vortex chamber 6 from the collector pipe 5a of the exhaust manifold 5 through the inlet hole 6e collides with the receiving surface 6f to be diffused three-dimensionally. Specifically, the receiving surface 6f is located right in front of the inlet hole 6e to which the collector pipe 5a is joined. That is, the receiving surface 6f extends in a direction substantially perpendicular to a flowing direction (i.e., a streamline) of the exhaust gas emitted from the collector pipe 5a. In other words, the receiving surface 6f extends such that an angle between a tangent line to the receiving surface 6f and a stream line of the exhaust gas emitted from the collector pipe 5a is substantially 90 degrees.

Given that the collector pipe 5a extend in a straight line, the exhaust gas emitted from the collector pipe 5a flows along a center axis of the collector pipe 5a. In this case, therefore, the receiving surface 6f may be formed at a portion of the cylindrical wall 6a to extend perpendicular to the center axis of the collector pipe 5a. Whereas, given that the collector pipe 5a is bent or curved, the exhaust gas flows through the collector pipe 5a along an inner surface of radially outer side of the collector pipe 5a. In this case, therefore, the receiving surface 6f may be displaced in a circumferential direction of the cylindrical wall 6a to a portion to extend perpendicular to a tangential line of the collector pipe 5a.

A connector pipe 7 is joined to the outlet hole 6c of the vortex chamber 6, and an exhaust gas purification device 8 is connected to the vortex chamber 6 through the connector pipe 7. Therefore, carbon monoxide (CO), hydrocarbon (HC), nitrogen oxide (NOX), and particle matter (PM) are removed from the exhaust gas flowing out of the outlet hole 6c by the exhaust gas purification device 8. That is, the exhaust gas flowing out of the outlet hole 6c is purified by the exhaust gas purification device 8. For example, as the engines arranged in the conventional vehicles, a catalyst converter may be adopted as the exhaust gas purification device 8.

In order to recirculate the exhaust gas to the intake pipe of the intake manifold, an EGR (i.e., Exhaust Gas Recirculation) passage 9 is joined to a downstream section of the connector pipe 7 in the vicinity of the exhaust gas purification device 8. In addition, in order to control a flow rate of the exhaust gas flowing through the EGR passage 9, an EGR valve 10 is arranged in the EGR passage 9.

An air/fuel ratio sensor 11 is arranged in an upstream section of the connector pipe 7 in the vicinity of the vortex chamber 6. The air/fuel ratio sensor 11 measures an amount of oxygen in the exhaust gas flowing through the connector pipe 7, and a detection signal of the air/fuel ratio sensor 11 is transmitted to a controller 12 controlling e.g., the EGR valve 10 and a fuel injector.

Specifically, the controller 12 is an electronic control unit comprising a microcomputer. According to the exemplary embodiment of the present disclosure, the controller 12 is configured to control e.g., an amount of intake air, an amount of fuel injection, and an opening degree of the EGR valve 10, based on a required torque to be generated by the engine 1, a rotational speed of the engine 1, and the signal transmitted from the air/fuel ratio sensor 11.

In the engine 1 having the foregoing structure, the air-fuel mixture is combusted in each of the cylinders 2, and the resultant exhaust gas is expelled from the cylinders 2 consecutively to the exhaust manifold 5. Therefore, the constituents of the exhaust gas flowing through the exhaust manifold 5 are changed depending on the constituents of the exhaust gas expelled from each of the cylinders 2. Since the exhaust gas is discharged consecutively from the cylinders 2 to the exhaust manifold 5, the exhaust gas is discharged continuously from the exhaust manifold 5 to flow into the vortex chamber 6.

As indicated by the arrows in FIGS. 2A and 2B, the exhaust gas flowing into the vortex chamber 6 collides with the receiving surface 6f opposed to the downstream end of the collector pipe 5a of the exhaust manifold 5. Consequently, the exhaust gas is diffused three-dimensionally to create vortexes on both sides of the main flow of the exhaust gas not only in the circumferential direction as illustrated in FIG. 2A, but also in the vertical direction as illustrated in FIG. 2B. Therefore, the exhaust gas will not be discharged Immediately from the vortex chamber 6, and temporarily remains in the vortex chamber 6 while being diffused therein. The exhaust gas remaining in the vortex chamber 6 is mixed with the following exhaust gas flowing continuously into the vortex chamber 6, and as a result, the constituents of the exhaust gas in the vortex chamber 6 are averaged. Then, the exhaust gas whose constituents are averaged is emitted from the vortex chamber 6 into the connector pipe 7.

Thus, the constituents of the exhaust gas flowing into the vortex chamber 6 temporarily remains in the vortex chamber 6, and the constituents of the exhaust gas are averaged in the vortex chamber 6. Therefore, in order not to allow the exhaust gas to immediately flow out of the vortex chamber 6, the outlet hole 6c of the vortex chamber 6 is preferably isolated from the receiving surface 6f in a predetermined distance determined based on an experimental result.

The exhaust gas flowing into the connector pipe 7 is partially recirculated to the intake manifold for supplying air to the cylinders 2 through the EGR passage 9. Whereas, the rest of the exhaust gas flows into the exhaust gas purification device 8. Consequently, carbon monoxide (CO), hydrocarbon (HC), nitrogen oxide (NOx), and particle matter (PM) are removed from the rest of the exhaust gas by the exhaust gas purification device 8, and the exhaust gas purified by the exhaust gas purification device 8 is emitted to the outside.

Since the EGR passage 9 is connected to the connector pipe 7 connecting the vortex chamber 6 to the exhaust gas purification device 8, the exhaust gas whose constituents are averaged in the vortex chamber 6 is recirculated to the cylinders 2 through the EGR passage 9. Therefore, variations in concentrations of oxygen and carbon dioxide in the air-fuel mixture in the cylinders 2 may be reduced so that the constituents of the air-fuel mixture in the cylinders 2 may be controlled properly. That is, an oxygen concentration in the air-fuel mixture will not be reduced excessively, in other words, a carbon dioxide concentration in the air-fuel mixture will not be increased excessively. For this reason, an occurrence of engine misfire may be prevented. Likewise, the oxygen concentration in the air-fuel mixture will not be increased excessively, in other words, the carbon dioxide concentration in the air-fuel mixture will not be reduced excessively. For this reason, nitrogen oxide (Nox) will not be generated undesirably.

Moreover, since the air/fuel ratio sensor 11 is arranged in the connector pipe 7, a variation in the detection values of the air/fuel ratio sensor 11 may be reduced. Therefore, it is not necessary to change an opening degree of the EGR valve 10 frequently to control a flow rate of the exhaust gas recirculated through the EGR passage 9. In addition, a control amount of the opening degree of the EGR valve 10 may be reduced. For these reasons, a control of the EGR valve 10 may be simplified.

Further, since the EGR passage 9 is connected to the connector pipe 7 upstream of the exhaust gas purification device 8, an internal pressure of the EGR passage 9 in the upstream section close to the connector pipe 7 may be maintained higher than that in the downstream section close to the intake pipe. Therefore, a pressure difference in the EGR passage 9 required to recirculate the exhaust gas to the intake pipe may be ensured so that the exhaust gas may be recirculated certainly to the intake pipe.

Furthermore, since the air/fuel ratio sensor 11 is arranged in the connector pipe 7, an ample amount of the exhaust gas passes through the air/fuel ratio sensor 11. Therefore, the air/fuel ratio sensor 11 is allowed to measure an amount of oxygen contained in the exhaust gas flowing through the connector pipe 7 accurately and stably. In addition, since the air/fuel ratio sensor 11 is arranged upstream of the EGR passage 9 joined to the downstream section of the connector pipe 7, an amount of oxygen contained in the exhaust gas may be measured by the air/fuel ratio sensor 11 before a flow rate of the exhaust gas decreases. Therefore, the air/fuel ratio sensor 11 is allowed to accurately measure an amount of oxygen contained in the exhaust gas flowing through the connector pipe 7.

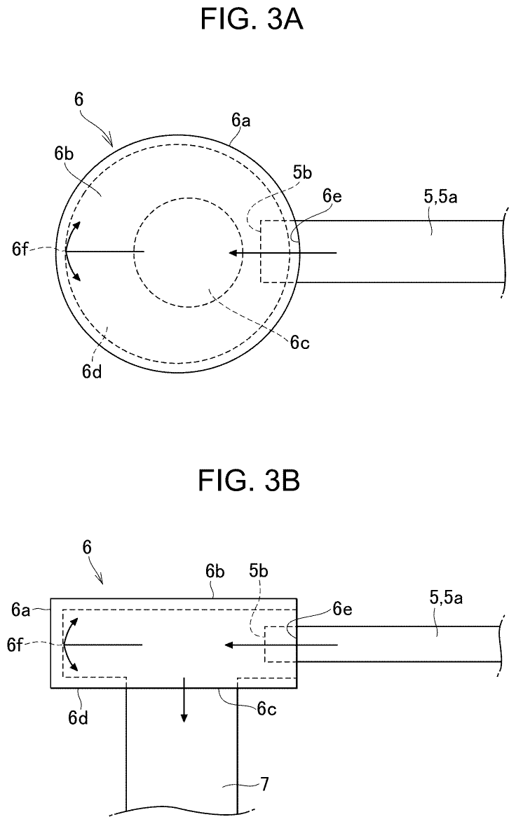

Thus, the exhaust gas flowing into the vortex chamber 6 collides with the receiving surface 6f to be diffused, and the exhaust gas diffused in the vortex chamber 6 is mixed with the exhaust gas flowing continuously into the vortex chamber 6. For these purposes, it is preferable to flow the exhaust gas along the inner wall surface of the vortex chamber 6 utilizing the Coanda effect. To this end, according to another example shown in FIGS. 3A and 3B, the downstream end (i.e., an outlet) of the collector pipe 5a of the exhaust manifold 5 protrudes into the vortex chamber 6.

According to another example, therefore, the exhaust gas is allowed to jet out of the collector pipe 5a of the exhaust manifold 5. For this reason, momentum of the exhaust gas may be maintained until colliding with the receiving surface 6f so that the exhaust gas may be diffused efficiently in the vortex chamber 6. In addition, a flow velocity of the exhaust gas may also be maintained so that the exhaust gas flowing out of the outlet 5b of the collector pipe 5a of the exhaust manifold 5 flows toward the receiving surface 6f together with the exhaust gas remaining in the vicinity of the outlet 5b. For this reason, the exhaust gas may be diffused efficiently in the vortex chamber 6.

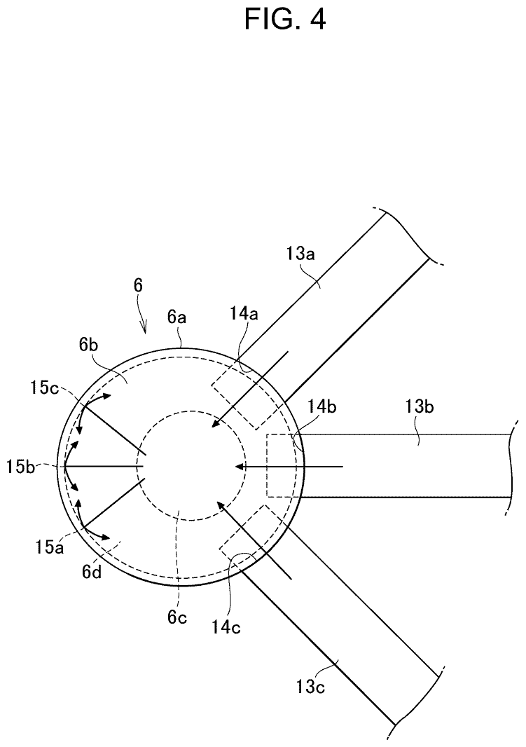

According to the foregoing examples, the exhaust gasses flowing through the header pipes of the exhaust manifold 5 join together in the collector pipe 5a, and then the unified exhaust gas flows into the vortex chamber 6. Instead, according to still another example shown in FIG. 4, the exhaust gasses may be discharged directly from the cylinders 2 into the vortex chamber 6. According to still another example, a first header pipe 13a is connected to the exhaust port of the first cylinder 2a, a second header pipe 13b is connected to the exhaust port of the second cylinder 2b, and a third header pipe 13c is connected to the exhaust port of the third cylinder 2c.

As illustrated in FIG. 4, according to still another example, a first inlet hole 14a, a second inlet hole 14b, and a third inlet hole 14c are formed in the vortex chamber 6. A downstream end of the first header pipe 13a is connected to the first inlet hole 14a, a downstream end of the second header pipe 13b is connected to the second inlet hole 14b, and a downstream end of the third header pipe 13c is connected to the third inlet hole 14c. Therefore, the exhaust gas flowing through the first header pipe 13a flows into the vortex chamber 6 through the first inlet hole 14a, the exhaust gas flowing through the second header pipe 13b flows into the vortex chamber 6 through the second inlet hole 14b, and the exhaust gas flowing through the third header pipe 13c flows into the vortex chamber 6 through the third inlet hole 14c. According to still another example, a first receiving surface 15a is opposed to the first inlet hole 14a to which the first header pipe 13a is joined, a second receiving surface 15b is opposed to the second inlet hole 14b to which the second header pipe 13b is joined, and a third receiving surface 15c is opposed to the third inlet hole 14c to which the third header pipe 13c is joined. In other words, the first receiving surface 15a extends in a direction substantially perpendicular to a streamline of the exhaust gas emitted from the first header pipe 13a, the second receiving surface 15b extends in a direction substantially perpendicular to a streamline of the exhaust gas emitted from the second header pipe 13b, and the third receiving surface 15c extends in a direction substantially perpendicular to a streamline of the exhaust gas emitted from the third header pipe 13c.

According to still another example, the exhaust gas flowing out of the first header pipe 13a collides with the first receiving surface 15a, the exhaust gas flowing out of the second header pipe 13b collides with the second receiving surface 15b, and the exhaust gas flowing out of the third header pipe 13c collides with the third receiving surface 15c. Therefore, the exhaust gases flowing out of the header pipes 13a, 13b, and 13c are mixed and agitated in the vortex chamber 6 so that the constituents of the exhaust gases are averaged in the vortex chamber 6. Consequently, a variation in the constituents of the exhaust gas recirculated through the EGR passage 9 may be reduced so that the constituents of the air-fuel mixture in the cylinders 2 may be controlled properly. Accordingly, an oxygen concentration in the air-fuel mixture will not be reduced excessively, in other words, a carbon dioxide concentration in the air-fuel mixture will not be increased excessively. For this reason, an occurrence of engine misfire may be prevented. Likewise, the oxygen concentration in the air-fuel mixture will not be increased excessively, in other words, the carbon dioxide concentration in the air-fuel mixture will not be reduced excessively. For this reason, nitrogen oxide (Nox) will not be generated undesirably.

What is claimed is:

1. An engine, comprising:
a plurality of cylinders;
a header pipe that is joined to the cylinder so that exhaust gas emitted from the cylinder flows therethrough;
an exhaust gas recirculation passage through which the exhaust gas emitted from the cylinder is recirculated to an intake pipe extending upstream of the cylinder;
a vortex chamber to which the header pipe is connected;
a receiving surface that is formed in the vortex chamber such that the exhaust gas flowing into the vortex chamber from the header pipe collides with the receiving surface to be diffused in the vortex chamber;
an exhaust gas purification device that purifies the exhaust gas; and
a connector pipe connecting the vortex chamber to the exhaust gas purification device,
wherein one end of the exhaust gas recirculation passage is joined to the connector pipe.

2. The engine as claimed in claim 1, further comprising:
an exhaust gas recirculation valve that alters an opening degree of the exhaust gas recirculation passage;
a sensor that transmits a detection signal representing an amount of oxygen contained in the exhaust gas; and
a controller that controls the exhaust gas recirculation valve based on the detection signal transmitted from the sensor,
wherein the sensor is arranged in the connector pipe.

3. The engine device as claimed in claim 1, wherein the receiving surface extends in a direction perpendicular to a streamline of the exhaust gas emitted from the header pipe.

4. The engine as claimed in claim 1, wherein one end of the header pipe protrudes into the vortex chamber.
